(19) United States
(12) Patent Application Publication
(10) Pub. No.: US 2026/0154438 A1
(43) Pub. Date: Jun. 4, 2026

(54) INTELLIGENT CYBERSECURE DATA SYSTEM FOR ORCHESTRATING RELATIONAL, NOSQL, GRAPH, AND ANALYTICAL DATABASES IN MULTI-CLOUD ENVIRONMENTS

(71) Applicant: Anisha GUPTA, South Brunswick, NJ (US)

(72) Inventor: Anisha GUPTA, South Brunswick, NJ (US)

(21) Appl. No.: 19/458,435

(22) Filed: Jan. 23, 2026

(51) Int. Cl. G06F 21/62; G06F 21/53

(52) U.S. Cl. CPC G06F 21/6218; G06F 21/53

(57) ABSTRACT

The present invention relates to an intelligent cybersecure data system configured to orchestrate heterogeneous database technologies across multi-cloud computing environments through processor-executed coordination and security validation mechanisms. The system establishes concurrent communication with relational, non-relational, graph-structured, and analytical database instances deployed across geographically distributed cloud infrastructures and performs structured metadata interpretation to construct an internal unified representation of database structures and dependencies. Incoming data access requests are decomposed into database-specific execution fragments, subjected to granular security enforcement, and adaptively scheduled based on real-time cloud conditions and behavioral risk assessment. Continuous monitoring of execution behavior enables detection of anomalous access patterns and selective mitigation without disrupting unaffected database operations.

### FIELD OF THE INVENTION

The present invention relates to the field of enterprise data infrastructure and cybersecurity, and more particularly to an intelligent cybersecure data system and corresponding method for orchestrating heterogeneous database technologies including relational databases, NoSQL databases, graph databases, and analytical databases deployed across distributed multi-cloud computing environments. The invention specifically addresses secure orchestration, adaptive workload coordination, real-time threat detection, and integrity-preserving data operations across hybrid and federated cloud infrastructures.

### BACKGROUND OF THE INVENTION

Modern enterprises increasingly rely on heterogeneous database ecosystems deployed across multiple public and private cloud platforms to support transactional processing, analytics, artificial intelligence workloads, and real-time decision systems. However, existing database management and orchestration frameworks are typically siloed, database-type specific, and inadequately secured against evolving cyber threats, particularly in multi-cloud environments where data traverses heterogeneous trust boundaries. Conventional solutions lack unified orchestration intelligence capable of dynamically coordinating relational, NoSQL, graph, and analytical databases while simultaneously enforcing adaptive cybersecurity controls at scale.

Existing database orchestration platforms also fail to incorporate continuous threat intelligence, behavior-based anomaly detection, and cryptographically verifiable data lineage into orchestration decisions. As a result, enterprises experience fragmented security enforcement, inconsistent policy application, delayed threat response, and reduced visibility into cross-database relationships and dependencies. Furthermore, traditional systems do not adequately leverage artificial intelligence to optimize workload placement, security posture, and performance trade-offs in real time across cloud environments.

Accordingly, there exists a technical need for an intelligent cybersecure data system that structurally integrates multi-database orchestration, AI-driven security intelligence, and multi-cloud coordination into a single machine-level architecture capable of executing secure, adaptive, and verifiable database operations at enterprise scale.

The rapid evolution of enterprise computing has resulted in organizations increasingly relying on complex data ecosystems composed of multiple database technologies operating concurrently across distributed cloud infrastructures. Modern enterprises routinely deploy relational databases for transactional consistency, NoSQL databases for scalability and schema flexibility, graph databases for relationship-intensive workloads, and analytical databases for large-scale reporting and decision support. These databases are often distributed across hybrid and multi-cloud environments involving public clouds, private clouds, and on-premise data centers. While this architectural diversity enables flexibility and performance optimization, it has also introduced significant technical challenges related to orchestration, security, interoperability, and operational governance.

Existing database management solutions were largely designed for homogeneous environments where a single database type operated within a controlled infrastructure boundary. Traditional relational database management systems focus primarily on ACID compliance, structured schema enforcement, and centralized access control. Although mature and reliable, such systems lack native capabilities for integrating or coordinating with NoSQL, graph, or analytical databases, particularly when deployed across multiple cloud platforms. As enterprises expand beyond single-database paradigms, these systems become insufficient for handling cross-database workflows, distributed query execution, and unified security enforcement.

To address heterogeneity, several database orchestration and middleware platforms have emerged that provide abstraction layers over multiple database types. These solutions typically offer connectors or adapters that allow applications to interact with different databases through a unified interface. However, such platforms often operate at a superficial abstraction level, translating queries or routing requests without deep awareness of underlying database semantics, performance characteristics, or security contexts. As a result, orchestration decisions are frequently static or rule-based, leading to suboptimal workload placement, inefficient resource utilization, and limited adaptability to dynamic enterprise conditions.

In multi-cloud environments, existing solutions face additional constraints due to differences in cloud provider architectures, security models, networking configurations, and compliance requirements. Many orchestration platforms rely on manual configuration or predefined templates to manage databases across clouds. These approaches lack real-time intelligence and are unable to dynamically respond to changes such as shifting workloads, emerging threats, or evolving compliance policies. Consequently, enterprises often experience configuration drift, inconsistent policy enforcement, and increased operational overhead when managing databases across multiple cloud environments.

From a cybersecurity perspective, current database security solutions predominantly rely on perimeter-based defenses, static access controls, and signature-based threat detection. Firewalls, role-based access control mechanisms, and encryption are widely used to protect databases, but these measures are typically implemented independently for each database system. Such siloed security implementations make it difficult to enforce consistent security policies across heterogeneous databases and clouds. Moreover, static security controls are increasingly ineffective against advanced threats that exploit legitimate credentials, lateral movement, or subtle behavioral anomalies rather than known attack signatures.

Some modern solutions incorporate security information and event management (SIEM) tools or database activity monitoring systems to enhance visibility into database operations. While these tools can collect logs and generate alerts, they generally operate as passive monitoring layers rather than integral components of the orchestration process. They lack the ability to influence real-time orchestration decisions, dynamically adjust security controls, or correlate activity across multiple database types and cloud environments in a unified manner. This separation between orchestration and security results in delayed threat response and fragmented situational awareness.

Machine learning-based security solutions have also been proposed to detect anomalies in database access patterns. These systems typically analyze historical logs to identify deviations from normal behavior. However, existing implementations are often limited to a single database platform or a specific type of workload. They do not account for cross-database relationships, interdependent workflows, or the broader orchestration context in which database operations occur. Additionally, many machine learning security tools function as add-ons rather than being deeply integrated into the data infrastructure, limiting their ability to proactively prevent threats during orchestration rather than merely detecting them after the fact.

Another significant limitation of existing solutions is the lack of unified data lineage, integrity verification, and trust assessment across distributed databases. In multi-cloud environments, data frequently moves between databases for replication, analytics, or integration purposes. Current systems often rely on application-level tracking or manual auditing to maintain data lineage and integrity. These approaches are error-prone, difficult to scale, and inadequate for ensuring end-to-end trust, particularly when data traverses multiple administrative and security domains. The absence of cryptographically verifiable lineage mechanisms increases the risk of undetected data tampering, inconsistency, and compliance violations.

Performance optimization in existing orchestration platforms is also constrained by limited contextual awareness. Many systems schedule or route database workloads based on static metrics such as resource availability or predefined priorities. They do not incorporate security risk, behavioral context, or real-time threat intelligence into orchestration decisions. This separation between performance management and security can lead to scenarios where workloads are optimally placed from a performance standpoint but exposed to elevated security risks, or conversely, where overly restrictive security measures degrade performance and availability.

Furthermore, existing solutions often require significant manual intervention for configuration, tuning, and policy updates. Administrators must define rules for database routing, security enforcement, and cloud placement, which are then applied uniformly regardless of changing conditions. This manual, static approach does not scale well in large enterprises with rapidly evolving data landscapes. It also increases the likelihood of misconfiguration, which remains one of the leading causes of security breaches in cloud environments.

Interoperability and enterprise integration present additional challenges. Many orchestration and security platforms are proprietary or tightly coupled to specific vendors, limiting their ability to integrate seamlessly with diverse enterprise systems, legacy applications, and emerging technologies. This vendor lock-in restricts architectural flexibility and complicates efforts to adopt best-of-breed solutions across different layers of the data stack. Moreover, existing systems often lack standardized interfaces for sharing security intelligence, orchestration state, or policy information across organizational boundaries.

In summary, while current database management, orchestration, and security solutions provide partial capabilities for handling heterogeneous and distributed data environments, they suffer from fundamental drawbacks. These include fragmented orchestration across database types, inadequate integration of security intelligence into real-time operations, limited adaptability to dynamic multi-cloud conditions, insufficient data lineage and integrity assurance, and heavy reliance on static configuration and manual oversight. As enterprise data ecosystems continue to grow in scale and complexity, these limitations hinder operational efficiency, increase security risk, and constrain the ability of organizations to fully leverage their data assets. These challenges underscore the need for an integrated, intelligent, and cybersecure data system capable of unifying orchestration, security, and multi-cloud management within a cohesive technical framework.

### SUMMARY OF THE INVENTION

The present invention discloses an intelligent cybersecure data system embodied as a machine-based orchestration infrastructure and an associated method for securely coordinating relational, NoSQL, graph, and analytical databases across multiple cloud environments. The system introduces a centralized yet distributed orchestration architecture that integrates database-type-aware connectors, an AI-driven security intelligence engine, cryptographic verification modules, and multi-cloud control interfaces to enable real-time orchestration with continuous security enforcement.

The invention further provides a method wherein database workloads are dynamically classified, authenticated, routed, and executed across heterogeneous databases based on contextual security posture, workload characteristics, and cloud resource availability. The method continuously evaluates behavioral telemetry, access patterns, and data lineage metadata to detect anomalies, enforce adaptive security policies, and prevent unauthorized or compromised database interactions.

By combining orchestration intelligence with cybersecure validation mechanisms, the invention ensures consistent performance, data integrity, regulatory compliance, and threat resilience across enterprise database environments, thereby overcoming the limitations of conventional database management and security frameworks.

The primary object of the present invention is to provide an intelligent cybersecure data system and corresponding method that enable unified orchestration of heterogeneous database technologies, including relational, NoSQL, graph, and analytical databases, across distributed multi-cloud environments while maintaining consistent security enforcement, operational reliability, and performance efficiency.

Another object of the invention is to overcome the limitations of conventional database management and orchestration systems by integrating cybersecurity intelligence directly into the orchestration layer, thereby enabling real-time threat-aware decision-making, adaptive security policy enforcement, and proactive mitigation of unauthorized or anomalous database activities during live enterprise operations.

A further object of the invention is to establish a machine-based orchestration architecture capable of dynamically coordinating database workloads across multiple cloud platforms based on contextual parameters including workload characteristics, data sensitivity, security posture, regulatory constraints, and resource availability, thereby ensuring optimal placement and execution of database operations without compromising security or compliance.

An additional object of the invention is to provide a system that continuously monitors database behavior, access patterns, and data movement across heterogeneous environments using artificial intelligence and machine learning models, enabling the creation of adaptive behavioral baselines and the detection of subtle anomalies that are not identifiable using static or signature-based security mechanisms.

Another object of the invention is to ensure end-to-end data integrity, authenticity, and trustworthiness across distributed database ecosystems by incorporating cryptographic verification mechanisms, secure key management, and verifiable data lineage tracking, thereby preventing undetected data tampering, unauthorized modification, or integrity degradation during cross-database and cross-cloud operations.

A further object of the invention is to reduce operational complexity and administrative overhead associated with managing multi-database, multi-cloud infrastructures by providing automated orchestration, self-adjusting security controls, and intelligent policy enforcement that adapt dynamically to changes in system state, threat landscape, and enterprise requirements.

Another object of the invention is to enhance performance and resource efficiency in enterprise database environments by enabling intelligent workload optimization that considers both operational metrics and security risk indicators, thereby achieving a balanced trade-off between throughput, latency, cost, and cybersecurity resilience.

An additional object of the invention is to provide seamless interoperability with existing enterprise applications, legacy systems, and cloud platforms through standardized interfaces and extensible orchestration mechanisms, allowing organizations to adopt the invention without disrupting existing workflows or requiring extensive reengineering of their data infrastructure.

A further object of the invention is to support scalability, fault tolerance, and high availability by employing a distributed orchestration architecture capable of operating reliably under varying workloads, infrastructure failures, and network conditions while maintaining consistent security and orchestration behavior across all system components.

Another object of the invention is to create a self-improving cybersecure data ecosystem in which orchestration strategies, security policies, and threat detection models evolve over time based on observed behavior, historical data, and feedback from enterprise operations, thereby ensuring long-term effectiveness, adaptability, and resilience in rapidly changing multi-cloud and cybersecurity environments.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of an intelligent cybersecure data system for orchestrating heterogeneous databases across multi-cloud computing environments; and

FIG. 2 displays flow chart of a computer-implemented method for cybersecure orchestration of heterogeneous databases across multi-cloud computing environments.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

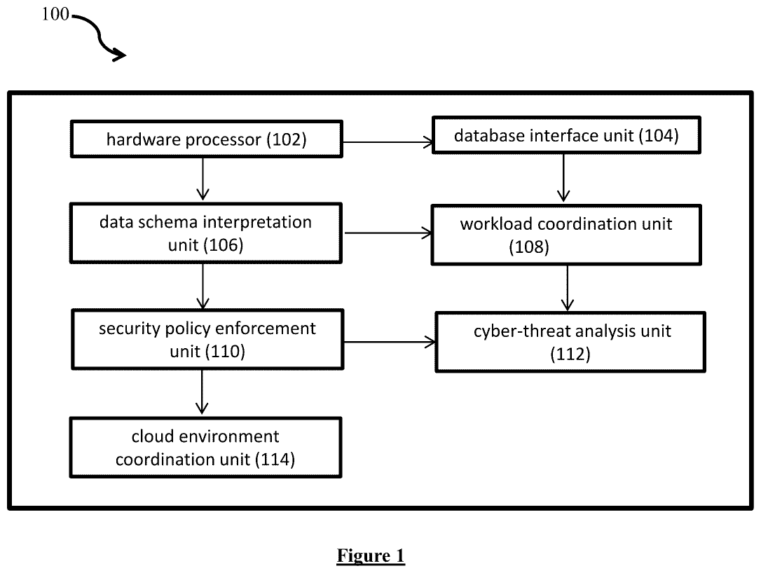

Referring to FIG. 1, a block diagram of a An intelligent cybersecure data system for orchestrating heterogeneous databases across multi-cloud computing environments is illustrated. The system 100 comprises: at least one hardware processor (102) operatively coupled to a non-transitory memory storing executable configuration logic; a database interface unit (104) electrically connected to the hardware processor and configured to establish concurrent, protocol-specific communication sessions with a plurality of database instances comprising at least one relational database instance, at least one non-relational key-value or document-oriented database instance, at least one graph-structured database instance, and at least one analytical columnar database instance deployed across physically distinct cloud infrastructures; a data schema interpretation unit (106) configured to extract structural metadata, indexing attributes, query execution constraints, and data relationship descriptors from each connected database instance by interrogating native catalog structures and runtime descriptors without modifying underlying database schemas; a workload coordination unit (108) configured to receive incoming data access requests, decompose each request into database-specific execution fragments based on extracted structural metadata, and schedule said fragments across the plurality of database instances while preserving transactional consistency, referential integrity, and query dependency ordering; a security policy enforcement unit (110) configured to apply multi-layer access control rules, cryptographic protection parameters, and identity verification constraints to each decomposed execution fragment prior to dispatch, wherein enforcement decisions are derived from a combination of database type, data sensitivity classification, and cloud residency attributes; a cyber-threat analysis unit (112) configured to monitor execution behavior patterns, access frequency distributions, and cross-database traversal characteristics in real time, and to generate threat state indicators when observed behavior deviates from stored baseline behavioral profiles; and a cloud environment coordination unit (114)configured to maintain synchronized state awareness of resource availability, network latency, jurisdictional compliance constraints, and failover readiness across the plurality of cloud infrastructures, thereby enabling adaptive orchestration decisions without interrupting database availability.

In an embodiment, the database interface unit (104) comprises a plurality of isolated communication adapters, each adapter being statically bound to a specific database interaction protocol and configured to perform query translation, response normalization, and error state encapsulation such that database-specific failure conditions are prevented from propagating to other database instances within the system.

In an embodiment, the data schema interpretation unit (106) is further configured to construct an internal unified structural representation stored in the memory, the representation comprising normalized entity descriptors, relationship adjacency mappings, and attribute constraint vectors derived from heterogeneous database schemas, thereby enabling cross-database dependency resolution without direct data replication.

In an embodiment, the workload coordination unit (108) is configured to dynamically reorder execution fragments based on real-time feedback received from the cloud environment coordination unit, such that query execution paths are modified in response to detected latency spikes, resource saturation conditions, or cloud service degradation events while maintaining logical correctness of query results.

In an embodiment, the security policy enforcement unit (110) comprises a cryptographic control sub-unit configured to apply database-type-specific encryption mechanisms including record-level encryption for relational databases, document-level encryption for non-relational databases, edge-level encryption for graph databases, and column-level encryption for analytical databases, with cryptographic keys being managed independently for each cloud environment.

In an embodiment, the cyber threat analysis unit (112) is configured to generate behavioral fingerprints representing normal operational patterns for each database instance, the fingerprints being derived from historical query structure distributions, execution timing profiles, and inter-database access correlations, and wherein deviation beyond stored tolerance thresholds results in automatic restriction of orchestration privileges for affected execution fragments.

In an embodiment, the cyber threat analysis unit (112) further comprises a temporal correlation sub-unit configured to evaluate sequential access patterns across multiple database types within a defined time window, thereby detecting lateral movement attempts that span relational, non-relational, graph, and analytical databases across different cloud environments.

In an embodiment, the cloud environment coordination unit (114) is configured to enforce data residency and regulatory compliance constraints by restricting orchestration paths that would result in prohibited cross-border data movement, such restrictions being enforced at the execution fragment level rather than at the full query level.

In an embodiment, the workload coordination unit (108) is configured to maintain a distributed execution ledger stored in the memory, the ledger recording execution provenance data comprising originating database identifiers, transformation operations applied, security policies enforced, and cloud environments traversed, thereby enabling post-execution forensic analysis without accessing raw data contents.

In an embodiment, the hardware processor (102) is further configured to selectively activate the cyber threat analysis unit based on dynamically computed risk scores associated with incoming data access requests, such that low-risk operations are processed with reduced computational overhead while high-risk operations are subjected to enhanced monitoring and security validation.

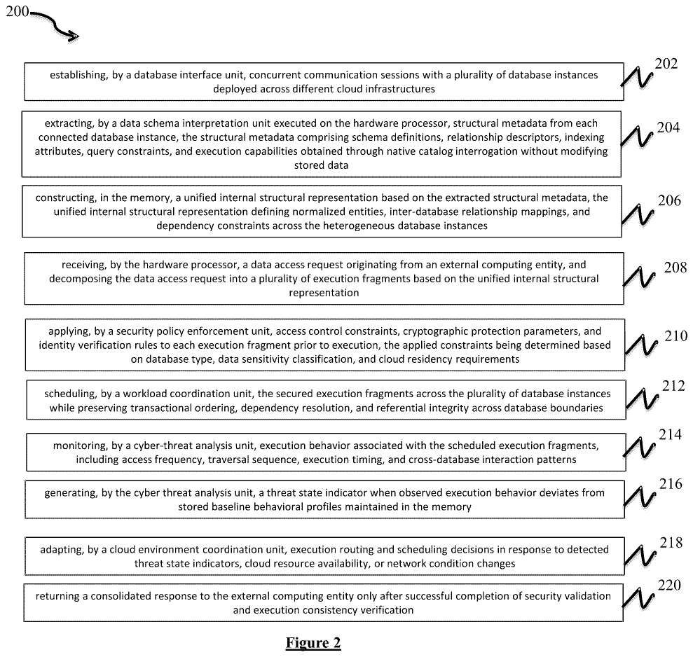

Referring to FIG. 2, a flow chart for a method for computer-implemented method for cybersecure orchestration of heterogeneous databases across multi-cloud computing environments, the method comprising the steps of is illustrated. The method 200 comprises:
At step 202, the method 200 includes establishing, by a database interface unit, concurrent communication sessions with a plurality of database instances deployed across different cloud infrastructures, the plurality of database instances comprising at least one relational database instance, at least one non-relational database instance, at least one graph-structured database instance, and at least one analytical database instance, each communication session being established using a database-specific interaction protocol;
At step 204, the method 200 includes extracting, by a data schema interpretation unit executed on the hardware processor, structural metadata from each connected database instance, the structural metadata comprising schema definitions, relationship descriptors, indexing attributes, query constraints, and execution capabilities obtained through native catalog interrogation without modifying stored data;
At step 206, the method 200 includes constructing, in the memory, a unified internal structural representation based on the extracted structural metadata, the unified internal structural representation defining normalized entities, inter-database relationship mappings, and dependency constraints across the heterogeneous database instances;
At step 208, the method 200 includes receiving, by the hardware processor, a data access request originating from an external computing entity, and decomposing the data access request into a plurality of execution fragments based on the unified internal structural representation;
At step 210, the method 200 includes applying, by a security policy enforcement unit, access control constraints, cryptographic protection parameters, and identity verification rules to each execution fragment prior to execution, the applied constraints being determined based on database type, data sensitivity classification, and cloud residency requirements;
At step 212, the method 200 includes scheduling, by a workload coordination unit, the secured execution fragments across the plurality of database instances while preserving transactional ordering, dependency resolution, and referential integrity across database boundaries;
At step 214, the method 200 includes monitoring, by a cyber-threat analysis unit, execution behavior associated with the scheduled execution fragments, including access frequency, traversal sequence, execution timing, and cross-database interaction patterns;
At step 216, the method 200 includes generating, by the cyber threat analysis unit, a threat state indicator when observed execution behavior deviates from stored baseline behavioral profiles maintained in the memory;
At step 218, the method 200 includes adapting, by a cloud environment coordination unit, execution routing and scheduling decisions in response to detected threat state indicators, cloud resource availability, or network condition changes; and
At step 220, the method 200 includes returning a consolidated response to the external computing entity only after successful completion of security validation and execution consistency verification.

In an embodiment, establishing concurrent communication sessions comprises initializing isolated protocol-bound communication adapters for each database instance, such that query translation, response normalization, and error handling are performed independently for each database type to prevent cross-database fault propagation.

In an embodiment, extracting structural metadata further comprises performing read-only introspection operations to derive schema evolution history, constraint enforcement rules, and query optimization hints without issuing data modification commands to the connected database instances.

In an embodiment, decomposing the data access request comprises partitioning the request into execution fragments aligned with database-specific query capabilities and data locality constraints, such that each execution fragment is executable within a single database instance without requiring direct cross-database joins.

In an embodiment, applying cryptographic protection parameters comprises selecting encryption granularity based on database type, including record-level encryption for relational databases, document-level encryption for non-relational databases, relationship-level encryption for graph databases, and attribute-level encryption for analytical databases.

In an embodiment, monitoring execution behavior further comprises generating temporal correlation data representing ordered sequences of database access events occurring within a defined time window across multiple database instances deployed in different cloud infrastructures.

In an embodiment, generating the threat state indicator comprises comparing the temporal correlation data against historical execution fingerprints stored in the memory and determining lateral traversal risk based on deviation magnitude and sequence abnormality.

In an embodiment, adapting execution routing further comprises rerouting selected execution fragments to alternative cloud infrastructures when latency thresholds, service degradation indicators, or jurisdictional compliance violations are detected.

In an embodiment, scheduling the secured execution fragments further comprises maintaining a distributed execution ledger in the memory, the ledger recording provenance information including originating database identifiers, applied security policies, execution timestamps, and cloud environment identifiers.

In an embodiment, generating the consolidated response further comprises suppressing partial execution results associated with execution fragments that triggered a threat state indicator, while allowing completion of unaffected execution fragments.

In an embodiment, scheduling the secured execution fragments further comprises maintaining a distributed execution ledger in the memory, the ledger recording provenance information including originating database identifiers, applied security policies, execution timestamps, and cloud environment identifiers, and wherein generating the consolidated response further comprises suppressing partial execution results associated with execution fragments that triggered a threat state indicator, while allowing completion of unaffected execution fragments.

In this embodiment, the secured execution fragments are not only scheduled for parallel or serialized execution, but are also continuously registered within a distributed execution ledger that operates as a tamper-resistant control layer across the multi-cloud environment. When each fragment is generated, the system writes a provenance record into the ledger containing the unique identifier of the source database from which the fragment is derived, a cryptographic reference to the security policy set that governs that fragment, the precise execution start and completion timestamps, and the identifier of the cloud region or infrastructure in which the fragment is executed. The ledger is replicated across coordinating nodes using a consensus-based commit protocol, so that every state transition of a fragment—from scheduling, to execution, to completion, or to termination—is immutably preserved and cannot be altered by a compromised node. During runtime, the cyber-threat analysis unit continuously correlates fragment behavior with the ledger entries. If any fragment exhibits anomalous behavior, such as abnormal access depth, excessive fan-out, or cross-instance propagation that exceeds learned baselines, the fragment is marked in the ledger as having entered a threat state, and a cryptographically sealed flag is appended to its provenance record.

When the system begins generating the consolidated response, the response assembler first queries the distributed execution ledger to determine the trust state of each fragment. Any fragment whose ledger record contains a threat state flag is automatically excluded from the response assembly pipeline, and any partial datasets produced by that fragment are suppressed before they can be merged with other results. At the same time, fragments that remain in a trusted state are allowed to complete normally, and their outputs are consolidated into the final response. For example, if a customer analytics query is decomposed into fragments executed across a private CRM database, a cloud data warehouse, and a regional reporting database, and only the cloud data warehouse fragment triggers a threat state due to abnormal data traversal, the system will discard only that fragment's output while still returning validated results from the CRM and reporting systems. The technical effect of this embodiment is that security enforcement becomes fine-grained at the fragment level rather than at the whole-query level, thereby preventing the propagation of compromised data, eliminating the need for full query termination, and ensuring continuous system availability with cryptographic traceability of every execution decision.

In an embodiment constructing the unified internal structural representation further comprises generating a cross-database semantic binding layer in the memory that assigns persistent logical identifiers to normalized entities derived from the structural metadata of each database instance, the semantic binding layer further storing bidirectional translation rules mapping database-native data types, constraint expressions, and relationship cardinalities into canonical execution models, and wherein decomposing the data access request further comprises resolving entity references within the request against the semantic binding layer to dynamically substitute database-native field identifiers and join semantics at execution time without modifying the unified internal structural representation.

In this embodiment, the unified internal structural representation is not limited to a static aggregation of schema metadata, but is extended through a cross-database semantic binding layer that operates as an active abstraction and translation fabric across all connected database instances. During system initialization and periodic synchronization, the metadata extraction engine ingests table definitions, collection schemas, index structures, foreign-key relationships, graph edges, and data type constraints from each heterogeneous database. These heterogeneous structures are normalized into canonical entity models, and each normalized entity is assigned a persistent logical identifier that remains stable even if the underlying database schema changes or is migrated to a different cloud platform. The semantic binding layer stores these identifiers together with bidirectional translation rules that define how each canonical attribute, constraint, and relationship cardinality maps to its database-native representation, including type conversions, join predicates, nullability rules, and referential constraints.

When a data access request is received, it is first expressed in terms of the canonical entities and attributes defined in the unified internal representation. During decomposition, the system resolves each entity reference against the semantic binding layer and dynamically substitutes the corresponding database-native field names, join paths, and constraint semantics required by the target database engine. This substitution occurs at execution time, so the unified internal structural representation itself remains unchanged, ensuring that all subsequent optimization, dependency analysis, and security validation steps continue to operate on a stable canonical model. For example, a logical reference to a “Customer” entity may be dynamically resolved to a JSON document path in a NoSQL store, a relational table with foreign-key joins in a SQL database, or a vertex type in a graph database, depending on where the fragment is executed. The technical effect of this embodiment is that cross-database interoperability is achieved without duplicating or rewriting schemas, enabling consistent query semantics, seamless schema evolution, and runtime portability of execution fragments across heterogeneous database environments while preserving correctness, performance, and security.

In an embodiment, establishing the concurrent communication sessions further comprises dynamically allocating isolated protocol-bound communication adapters within separate execution sandboxes, each sandbox maintaining an independent connection pool, retry policy, transaction scope, and query rewrite engine, and wherein the query rewrite engine is configured to transform decomposed execution fragments into database-native execution statements based on the extracted structural metadata and stored optimization hints, while suppressing unsupported operations and injecting execution guards to prevent recursive traversal and resource exhaustion across the heterogeneous database instances.

In this embodiment, concurrent communication with heterogeneous database instances is achieved through the dynamic creation of isolated, protocol-bound execution sandboxes, each sandbox being instantiated at runtime when an execution fragment is scheduled. For every target database, the system allocates a dedicated communication adapter that is bound to the native access protocol of that database, such as JDBC/ODBC for relational systems, REST or gRPC for cloud data services, and binary drivers for NoSQL or graph engines. Each adapter is deployed inside its own sandboxed execution container, which is logically and memory-isolated from all other sandboxes. Within each sandbox, an independent connection pool is maintained with configurable limits on maximum open sessions, idle timeouts, and failover endpoints, ensuring that congestion or failure in one database channel cannot propagate to other fragments. The sandbox further maintains a localized retry policy that defines back-off intervals, retry thresholds, and exception classification, as well as an independent transaction scope manager that enforces commit, rollback, and isolation behavior in accordance with the target database's capabilities.

When a decomposed execution fragment enters a sandbox, it is processed by the sandbox-resident query rewrite engine. This engine consults the extracted structural metadata and stored optimization hints, such as index availability, preferred join orders, partitioning strategies, and cost statistics, to transform the fragment from its canonical form into a database-native execution statement. During this transformation, the engine actively suppresses any operations that are unsupported by the target database, such as recursive common table expressions, cross-database joins, or vendor-specific functions, and replaces them with safe alternatives or staged execution patterns. In parallel, the rewrite engine injects execution guards into the generated statement, including depth limits, row caps, timeout clauses, and traversal counters, which prevent uncontrolled recursion, infinite graph walks, and excessive resource consumption. For example, if a fragment originally contains an unbounded hierarchical traversal, the engine rewrites it into a bounded iterative query with enforced termination conditions.

The technical effect of this embodiment is the creation of a fault-isolated, self-governing execution environment for each database connection, in which protocol handling, optimization, error recovery, and resource protection are performed independently. This prevents cascading failures, ensures predictable performance across heterogeneous systems, and enables safe, optimized execution of complex cross-database queries while protecting the underlying infrastructure from abuse, denial-of-service conditions, and uncontrolled resource exhaustion.

In an embodiment, applying the access control constraints further comprises performing attribute-level authorization resolution by intersecting identity context received from the external computing entity with column-level, field-level, or relationship-level security descriptors stored in the memory, and dynamically embedding filtered projection rules into each execution fragment such that unauthorized attributes are excluded prior to transmission to the

corresponding database instance, and wherein the identity verification rules further comprise validating cryptographic session tokens against a federated identity trust registry distributed across the multi-cloud computing environments.

In this embodiment, access control is enforced before any execution fragment is transmitted to a target database by resolving authorization at the attribute level rather than at the coarse table or dataset level. When a data access request is received, the system first extracts the identity context from the external computing entity, including user role, organization, privilege scope, jurisdiction, and session attributes derived from the cryptographic session token. This identity context is then intersected with security descriptors stored in memory, where each column, field, and inter-entity relationship is tagged with access classifications, sensitivity levels, and permissible role sets. The authorization engine evaluates these intersections in real time to determine exactly which attributes the requesting identity is permitted to access across the heterogeneous databases.

Once the permitted attribute set is resolved, the system dynamically rewrites each decomposed execution fragment to embed filtered projection rules that remove all unauthorized fields before the fragment is transmitted to the corresponding database instance. This ensures that disallowed data is never requested, processed, or returned by the database, eliminating the risk of leakage through intermediate results or post-processing filters. For example, if a user is authorized to view customer names but not financial identifiers, the fragment is rewritten so that only name fields are selected, while all sensitive columns are omitted from the query itself. In parallel, the cryptographic session token accompanying the request is validated against a federated identity trust registry that is distributed across the participating cloud environments. This registry synchronizes trusted issuers, revocation lists, and key rotation states, allowing the system to verify the authenticity, freshness, and scope of the identity token regardless of the cloud in which the fragment is executed.

The technical effect of this embodiment is that security enforcement becomes intrinsic to the execution path, rather than an external gate, by preventing unauthorized attributes from ever being accessed at the source. This results in fine-grained, zero-trust data access across multi-cloud infrastructures, reduces attack surfaces, and ensures regulatory compliance by enforcing least-privilege principles at execution time with cryptographic identity validation.

In an embodiment, monitoring the execution behavior further comprises generating a multi-dimensional behavior vector for each execution fragment, the multi-dimensional behavior vector comprising access depth, query fan-out, cross-instance propagation distance, execution latency variance, and data volume transfer rate, and wherein generating the threat state indicator further comprises classifying the multi-dimensional behavior vector against adaptive baseline envelopes stored in the memory that are dynamically recalibrated based on historical workload periodicity and cloud infrastructure performance drift.

In this embodiment, execution monitoring is implemented as a continuous behavioral profiling process in which each execution fragment is observed across its full lifecycle, from initial dispatch through completion. For every fragment, the system derives a multi-dimensional behavior vector that captures operational characteristics in real time, including the depth of entity or relationship traversal performed by the fragment, the fan-out rate indicating how many sub-queries or downstream calls are generated, the cross-instance propagation distance measuring how far the fragment's execution effects spread across interconnected databases, the variance in execution latency relative to expected norms, and the rate at which data is transferred between the database instance and the coordinating node. These parameters are computed from live execution traces, query plans, network telemetry, and result streaming statistics, and are continuously updated as the fragment progresses.

The resulting behavior vector is then classified against a set of adaptive baseline envelopes that are stored in memory and represent statistically learned ranges of normal behavior for similar fragments. These baselines are not static; they are dynamically recalibrated using historical workload data segmented by time-of-day, query category, database type, and cloud region, and are continuously adjusted to reflect infrastructure performance drift such as changing network latency or storage throughput. For example, a reporting query that normally executes during off-peak hours with low fan-out may be treated as anomalous if the same behavior occurs during a peak transactional window with elevated propagation distance and data transfer rates. When a behavior vector exceeds its corresponding baseline envelope in one or more dimensions beyond adaptive thresholds, the system classifies the fragment as entering a threat state and generates a corresponding threat state indicator.

The technical effect of this embodiment is the creation of a context-aware, self-learning anomaly detection mechanism that distinguishes malicious or compromised execution patterns from legitimate workload fluctuations. By correlating multiple behavioral dimensions and adapting to temporal and infrastructural changes, the system achieves high detection accuracy with reduced false positives, enabling proactive security enforcement without degrading normal system performance.

In an embodiment, adapting the execution routing and scheduling decisions further comprises computing a trust-weighted routing score for each candidate cloud infrastructure using threat state history, network latency statistics, and compliance region policies stored in the memory, and dynamically reassigning execution fragments to target database instances that satisfy a minimum trust-weight threshold while preserving inter-fragment dependency constraints encoded in the unified internal structural representation.

In this embodiment, execution routing is not fixed to a predefined cloud region or database endpoint, but is continuously adapted through a trust-aware decision process that evaluates the risk and suitability of each candidate cloud infrastructure in real time. For every available execution target, the system maintains a continuously updated trust profile in memory that aggregates historical threat state indicators, recent anomaly frequencies, and severity scores associated with that environment. This trust profile is combined with live network latency statistics and compliance region policies, such as data residency restrictions and regulatory classifications, to compute a trust-weighted routing score for each candidate cloud or database instance. The scoring function applies configurable weights so that, for example, a cloud region with low latency but repeated threat flags may receive a lower score than a slightly slower region with a clean security history and regulatory compliance.

When an execution fragment is ready to be scheduled, the routing engine evaluates the trust-weighted scores of all eligible target environments and selects only those that meet or exceed a minimum trust-weight threshold. If a previously selected target falls below this threshold due to a newly detected threat state or compliance change, the fragment is dynamically reassigned to a safer alternative without requiring the query to be reissued. During reassignment, the scheduler consults the unified internal structural representation to preserve inter-fragment dependency constraints, ensuring that execution order, data dependencies, and transactional relationships remain intact. For example, if a fragment that must execute before a dependent aggregation fragment is moved to a different cloud region, the scheduler updates the dependency graph to maintain the correct execution sequence and data flow.

The technical effect of this embodiment is that execution becomes resilient to compromised or degraded environments by automatically steering workloads toward trusted, compliant, and performant infrastructures. This reduces exposure to security risks, prevents execution bottlenecks caused by unstable regions, and maintains logical correctness across distributed systems, thereby achieving adaptive, risk-aware orchestration of cross-cloud database operations.

In an embodiment, constructing the unified internal structural representation further comprises generating a dependency resolution graph in the memory that encodes inter-fragment execution precedence, shared resource locks, and referential constraint propagation paths, and wherein scheduling the secured execution fragments further comprises traversing the dependency resolution graph to serialize or parallelize execution fragments based on detected contention, lock scope overlap, and transaction isolation requirements associated with the heterogeneous database instances.

In this embodiment, the unified internal structural representation is extended with a dependency resolution graph that acts as a live coordination model for all execution fragments derived from a single data access request. When the request is decomposed, each fragment is represented as a node in the graph, and directed edges are created to encode execution precedence relationships, such as when the output of one fragment is required as an input for another. In parallel, the system annotates the graph with shared resource locks, including table-level, row-level, index-level, or document-level locks extracted from the structural metadata and transaction requirements of the target databases. Referential constraint propagation paths are also encoded, allowing the graph to model how changes or reads in one fragment may impact dependent fragments across other database instances.

During scheduling, the execution controller traverses this dependency resolution graph to determine which fragments can safely run in parallel and which must be serialized to preserve data integrity. The traversal process evaluates detected contention, overlapping lock scopes, and transaction isolation levels required by each fragment, such as read-committed, repeatable-read, or serializable. If two fragments attempt to access the same constrained resource with incompatible isolation levels, the scheduler enforces serialization; if no conflict is detected, the fragments are dispatched concurrently. For example, an update fragment that modifies inventory records in a transactional database will be scheduled to complete before a reporting fragment that reads stock levels from a data warehouse, while unrelated analytics fragments may execute in parallel.

In an embodiment, receiving the data access request further comprises parsing the request into an intermediate canonical query form stored in the memory, the canonical query form defining abstract entity references, predicate trees, and aggregation semantics independent of database-specific syntax, and wherein decomposing the data access request further comprises mapping the canonical query form into execution fragments using rule-driven pattern substitution tables derived from the unified internal structural representation.

In this embodiment, when a data access request is received from an external computing entity, it is not processed directly in its original database-specific syntax, but is first transformed into an intermediate canonical query form that is stored in memory and used as the system's internal execution language. A dedicated parsing and normalization engine analyzes the request to identify the logical entities being referenced, the hierarchical predicate structure defining filtering conditions, and the aggregation semantics such as grouping, sorting, and computed measures. These elements are represented in an abstract, technology-agnostic format that is independent of whether the original request was expressed in SQL, a graph query language, or a REST-based query. By stripping away vendor-specific syntax and execution hints, the canonical form preserves only the semantic intent of the request, creating a stable representation that can be safely optimized, secured, and routed across heterogeneous database systems.

Once the canonical query form has been generated, the decomposition engine maps this abstract representation into a set of execution fragments using rule-driven pattern substitution tables that are derived from the unified internal structural representation. Each substitution rule encodes how a particular canonical entity pattern, predicate structure, or aggregation construct can be realized against one or more physical database schemas, taking into account join paths, index

availability, and supported operators. During decomposition, the engine matches sections of the canonical query tree against these rules and replaces them with fragment templates that reference the appropriate target databases. For example, a canonical “Order with Customer and Region” pattern may be substituted with one fragment targeting a transactional order database and another targeting a regional analytics store, with the relationship between them preserved through dependency metadata. The technical effect of this embodiment is that query translation becomes deterministic, extensible, and independent of query syntax, enabling consistent cross-database execution while allowing new database systems or schema changes to be accommodated simply by updating the substitution tables rather than rewriting application logic.

In an embodiment, generating the threat state indicator further comprises assigning a dynamic threat confidence score computed from weighted deviation factors associated with access frequency anomalies, traversal path irregularities, and cross-database correlation entropy, and wherein returning the consolidated response further comprises embedding an execution integrity token that cryptographically binds the response payload to the validated execution fragments and recorded security policy enforcement outcomes.

In this embodiment, the threat state indicator is not generated as a simple binary flag, but as a continuously updated confidence score that reflects the measured severity and likelihood of malicious or abnormal behavior. As each execution fragment is monitored, the cyber-threat analysis unit calculates a set of weighted deviation factors that quantify how far the fragment's behavior departs from its expected baseline. These factors include abnormal access frequency patterns, such as sudden bursts of repeated queries against sensitive entities, traversal path irregularities that indicate unexpected navigation across unrelated data domains, and cross-database correlation entropy that measures how unpredictably the fragment's data access patterns diverge from historically observed relationships. Each factor is assigned a dynamic weight based on its historical contribution to confirmed threat events and its contextual relevance, such as time of day or data sensitivity. The weighted factors are aggregated to compute a dynamic threat confidence score that evolves during execution, allowing the system to distinguish low-risk anomalies from high-confidence attack behaviors in real time.

When the execution completes and the consolidated response is prepared, the system embeds an execution integrity token within the response payload. This token is generated by cryptographically binding together a hash of the validated execution fragments, the final threat confidence states associated with each fragment, and the recorded outcomes of all applied security policies. The token is digitally signed using a trusted key managed by the system, enabling downstream systems or auditors to verify that the response was produced only from fragments that met security and integrity requirements and that no suppressed or compromised results were included. The technical effect of this embodiment is twofold: first, it enables risk-graded security enforcement rather than rigid binary decisions, and second, it provides tamper-evident proof that the returned data is both complete and policy-compliant, thereby strengthening trust, auditability, and non-repudiation across distributed execution environments.

In an embodiment, the cyber threat analysis unit further maintains rolling behavioral baselines segmented by database type, cloud region, time-of-day, and workload category, and wherein monitoring the execution behavior further comprises continuously updating the rolling behavioral baselines using exponentially decayed historical execution data to accommodate infrastructure drift and evolving access patterns without manual reconfiguration.

In this embodiment, the cyber-threat analysis unit does not rely on a single static profile of “normal” behavior, but instead maintains a set of rolling behavioral baselines that are segmented along multiple operational dimensions, including the type of database being accessed, the cloud region in which it is hosted, the time-of-day of execution, and the functional workload category of the query. Each segment represents a distinct behavioral context with its own statistical norms for access depth, query fan-out, latency patterns, and data transfer volumes. For example, analytical workloads executed against a cloud data warehouse during off-peak hours are modeled separately from transactional queries against a regional relational database during business hours, ensuring that legitimate workload differences are not misclassified as threats.

As execution fragments are processed, their observed behavior vectors are continuously incorporated into the corresponding baseline segments using an exponentially decayed historical update mechanism. In this process, recent execution data is given a higher weight, while older observations are progressively down-weighted, allowing the baseline to adapt naturally to changes in infrastructure performance, query optimization strategies, seasonal workload shifts, or data growth. If a cloud region undergoes a latency increase due to scaling events, or if a new application introduces higher query volumes, the baselines gradually shift to reflect the new operating conditions without requiring manual threshold tuning. The technical effect of this embodiment is a self-adapting anomaly detection framework that remains sensitive to genuine threats while avoiding false alarms caused by normal operational evolution, thereby providing continuous, low-maintenance security monitoring across dynamic multi-cloud environments.

In an embodiment, establishing concurrent communication sessions further comprises negotiating capability descriptors with each database instance to determine supported query operators, transaction isolation levels, and indexing mechanisms, and wherein decomposing the data access request further comprises selectively disabling unsupported operations and generating compensating execution fragments that emulate missing functionality through staged query execution across the plurality of database instances.

In this embodiment, before any execution fragments are transmitted, the system initiates a capability negotiation phase with each connected database instance as part of establishing the concurrent communication sessions. During this phase, the communication adapter queries the database engine to retrieve a capability descriptor that specifies the supported query operators, available aggregation and windowing functions, transaction isolation levels, indexing mechanisms, and limitations on joins, recursion, or subqueries. These descriptors are cached in memory and continuously refreshed so that any version upgrades, configuration changes, or cloud-managed feature updates are immediately reflected in the system's execution planning logic.

When the data access request is decomposed, the decomposition engine consults the stored capability descriptors to evaluate whether each target database can natively execute the required logical operations. If an operation is not supported, the system selectively disables that construct for the affected fragment and automatically generates one or more compensating execution fragments that emulate the missing functionality through staged execution. For example, if a database does not support window functions, the system first generates a fragment that retrieves the required base dataset, then produces a secondary fragment that performs the windowed aggregation in an intermediate processing layer or a different database that supports the operation. Similarly, if a target database lacks a required index, the system may route a filtering fragment to a more suitable instance and then propagate the reduced result set back to the original environment.

In an embodiment, returning the consolidated response further comprises validating cross-database consistency by comparing record counts, aggregation checksums, and referential linkage hashes generated by the plurality of database instances against expected values derived from the unified internal structural representation prior to releasing the response to the external computing entity.

In this embodiment, the consolidated response is not released immediately after fragment execution, but is first subjected to a cross-database consistency validation phase that ensures the integrity and coherence of the merged results. As each execution fragment completes, the corresponding database instance generates verification artifacts that include record counts for each result set, cryptographic or rolling checksums for aggregated values, and referential linkage hashes that summarize the integrity of key relationships between related entities. These artifacts are transmitted alongside the fragment results to the coordinating node.

Before assembling the final response, the system retrieves the expected structural and relational constraints from the unified internal structural representation, including cardinality rules, join relationships, and aggregation invariants. Using these expectations, the validation engine compares the received verification artifacts with the predicted or permissible ranges derived from the canonical model. For example, if a fragment returns customer records and another returns associated order records, the referential linkage hashes and counts are validated to ensure that no orphaned or duplicated relationships exist across the merged datasets. Similarly, aggregation checksums are compared to confirm that partial aggregations from different databases align with the overall canonical aggregation semantics.

Only when all verification checks fall within the expected constraints does the system release the consolidated response to the external computing entity. If any mismatch is detected, the response is withheld and flagged for re-execution or security review. The technical effect of this embodiment is the prevention of silent data corruption, incomplete merges, and cross-database inconsistency, thereby ensuring that the returned data is both logically correct and trustworthy even when sourced from multiple heterogeneous systems.

In an embodiment, the security policy enforcement unit further comprises a rule compilation engine that transforms policy definitions stored in the memory into executable constraint graphs, each constraint graph encoding permissible data scopes, cryptographic key references, access sequencing conditions, and cloud jurisdiction enforcement parameters, and wherein applying the access control constraints further comprises traversing the constraint graphs to inject runtime policy checks and encrypted data handlers into each execution fragment prior to scheduling.

In this embodiment, security policies are not enforced as static configuration rules, but are actively compiled into executable constraint graphs that become part of the runtime execution pipeline. Policy definitions stored in memory—such as role-based access rules, data classification tags, jurisdictional restrictions, encryption requirements, and sequencing constraints—are first processed by a rule compilation engine. This engine translates the high-level policy language into graph-based constraint models, where each node represents a control condition, cryptographic requirement, or data scope boundary, and each edge represents an enforcement dependency or evaluation sequence. The resulting constraint graphs encode, in machine-executable form, which data entities may be accessed, under what conditions, which cryptographic keys must be applied, the order in which access checks must occur, and which cloud regions are permitted for execution based on regulatory or organizational policies.

When execution fragments are prepared for scheduling, the access control engine traverses the corresponding constraint graphs to determine the exact enforcement actions required for each fragment. During this traversal, the system injects runtime policy checks directly into the fragment execution path, such as pre-condition verifications, jurisdiction validation gates, and cryptographic authorization checks. In parallel, encrypted data handlers are attached to the fragment so that any sensitive fields are automatically encrypted, decrypted, or tokenized using the cryptographic keys referenced in the constraint graph. For example, a fragment accessing personally identifiable information may be forced to execute only within a permitted region, require a specific key for field-level encryption, and pass an authorization check before any data is retrieved. The technical effect of this embodiment is that security becomes an intrinsic, dynamically enforced property of execution rather than an external control layer, ensuring continuous compliance, tamper resistance, and fine-grained protection across all stages of distributed query processing.

In an embodiment, extracting the structural metadata further comprises generating versioned schema snapshots for each connected database instance, the versioned schema snapshots being stored in the memory with temporal identifiers and compatibility markers, and wherein constructing the unified internal structural representation further comprises resolving schema version conflicts by applying precedence rules and structural normalization mappings to maintain backward compatibility during execution fragment generation.

In this embodiment, structural metadata is not treated as a single static description of each database, but is captured as a sequence of versioned schema snapshots that reflect how every connected database instance evolves over time. Whenever a schema is created, altered, or migrated, the metadata extraction engine generates a new snapshot that records table or collection definitions, field types, indexes, relationships, and constraints, and associates this snapshot with a temporal identifier and compatibility markers that indicate which canonical entities and prior schema versions it can interoperate with. These snapshots are stored in memory as a time-ordered lineage, allowing the system to reference not only the current structure of a database but also historical versions that may still be required by long-running processes or cached execution fragments.

When the unified internal structural representation is constructed or refreshed, the system analyzes all available snapshots and resolves schema version conflicts by applying precedence rules and structural normalization mappings. Precedence rules determine which version takes priority when multiple schemas describe the same logical entity, such as favoring the most recent compatible version or a version certified for regulatory compliance. Structural normalization mappings then reconcile differences in field names, data types, and relationship definitions, translating them into a stable canonical form that preserves backward compatibility. For example, if a column is renamed or split across versions, the normalization layer maps both the old and new representations to the same canonical attribute so that existing execution fragments continue to function without modification. The technical effect of this embodiment is that schema evolution across heterogeneous databases can occur without disrupting active queries or requiring manual reconfiguration, enabling continuous operation, long-term interoperability, and reliable execution fragment generation even in dynamic multi-cloud environments.

In an embodiment, monitoring the execution behavior further comprises correlating database audit logs, network telemetry, and execution trace metadata to generate a cross-layer activity profile for each execution fragment, and wherein generating the threat state indicator further comprises evaluating the cross-layer activity profile against composite risk signatures stored in the memory that encode known lateral movement patterns, privilege escalation behaviors, and anomalous access propagation structures; and wherein adapting the execution routing and scheduling decisions further comprises dynamically modifying fragment execution priority queues stored in the memory based on detected threat state indicators, cloud resource utilization metrics, and transaction urgency parameters, and selectively delaying, accelerating, or isolating execution fragments within secure execution pools to maintain consistency and security across the multi-cloud computing environments.

In this embodiment, execution monitoring is elevated from a single-layer observation mechanism to a correlated, cross-layer security intelligence process that fuses multiple independent telemetry sources into a unified behavioral view for each execution fragment. As fragments execute, the system continuously collects database audit logs that record accessed entities, privilege checks, and query execution paths, network telemetry that captures connection patterns, packet flow characteristics, and cross-region data movement, and execution trace metadata that describes internal processing stages, memory usage, and timing transitions within the execution pipeline. These heterogeneous signals are normalized and temporally aligned to generate a cross-layer activity profile that reflects not only what the fragment is doing at the data layer, but also how it is behaving across the network and execution infrastructure.

The cyber-threat analysis unit then evaluates this cross-layer activity profile against composite risk signatures stored in memory. Each risk signature encodes multi-step behavioral structures associated with known attack techniques, such as lateral movement across database instances, privilege escalation through abnormal role transitions, or anomalous propagation paths that traverse unrelated data domains. Rather than matching individual events, the system correlates sequences and structural patterns across layers, allowing it to detect stealthy, low-and-slow attacks that would evade isolated monitoring systems. When a profile matches or partially matches a composite signature, a threat state indicator is generated with a confidence level reflecting the degree of similarity and contextual severity.

Once a threat state is detected, the execution scheduler dynamically adapts routing and prioritization by modifying the fragment execution priority queues stored in memory. These adjustments are based not only on the threat state confidence but also on real-time cloud resource utilization metrics and transaction urgency parameters. Fragments associated with higher risk can be isolated into secure execution pools with restricted privileges, delayed to allow further inspection, or deprioritized to prevent rapid propagation, while time-critical and trusted fragments may be accelerated to preserve service continuity. The technical effect of this embodiment is a closed-loop, self-regulating execution environment in which security intelligence directly influences scheduling and routing decisions, enabling real-time containment of threats while maintaining data consistency, performance, and operational resilience across multi-cloud computing environments.

The hardware processor, non-transitory memory, database interface unit, data schema interpretation unit, workload coordination unit, security policy enforcement unit, cyber threat analysis unit, cloud environment coordination unit, protocol-bound communication adapters, cryptographic control sub-units, temporal correlation sub-units, execution ledger storage modules, and cloud state monitoring components recited in the foregoing system and method claims are each implemented as physically instantiated computing structures comprising semiconductor-based processing circuitry, hardware-executed logic controllers, bus-interconnected memory controllers, network interface controllers, and firmware-governed co-processing modules mounted on one or more server-grade computing nodes deployed across a distributed multi-cloud orchestration fabric. In particular, the at least one hardware processor comprises a multi-core CPU and hardware virtualization extensions executing within a secure execution environment, the non-transitory memory comprises physically addressable RAM, persistent solid-state storage, and firmware-resident configuration registers, and the database interface unit is realized through dedicated network interface cards, hardware protocol offload engines, and statically provisioned adapter controllers that electrically terminate database-specific communication sessions. The data schema interpretation unit is implemented through hardware-addressable parsing engines and metadata extraction logic blocks executing in protected memory spaces, while the workload coordination unit is embodied as a hardware-scheduled execution pipeline including task queues, dependency resolution circuits, transaction state buffers, and concurrency control registers. The security policy enforcement unit comprises hardware-based cryptographic accelerators, key isolation modules, identity verification circuits, and access-control logic gates that operate on execution fragments prior to dispatch. The cyber threat analysis unit is implemented using hardware counters, event tracing registers, temporal correlation buffers, and behavioral fingerprint comparison engines that continuously process execution telemetry in real time. The cloud environment coordination unit comprises network latency sensors, resource state registers, failover detection circuits, compliance rule engines, and routing decision controllers that interact directly with the processor interconnect fabric.

The present invention relates to an intelligent cybersecure data system configured to orchestrate heterogeneous databases deployed across multiple cloud computing environments while enforcing continuous security validation and adaptive execution control. The invention operates through coordinated interaction between hardware processors, memory-resident data structures, and dedicated processing units that collectively implement an technique orchestration flow designed to handle relational, non-relational, graph-structured, and analytical databases without requiring modification to native database management systems.

Upon initialization, the system establishes concurrent communication sessions with multiple database instances distributed across different cloud infrastructures. This is achieved by activating protocol-bound database interface units that are electrically coupled to the hardware processor. Each interface unit initiates a read-only negotiation sequence with its corresponding database instance to identify supported query semantics, structural exposure capabilities, indexing mechanisms, and permissible metadata access paths. During this phase, the system strictly avoids issuing data manipulation commands, ensuring that operational database state remains unchanged while enabling safe introspection.

Following connection establishment, the data schema interpretation unit executes a structured

extraction technique that interrogates native catalog structures, system views, and runtime descriptors exposed by each database instance. The extracted information includes schema definitions, attribute constraints, entity identifiers, relationship descriptors, execution limitations, and query optimization hints. This information is normalized and stored in the memory as a unified internal structural representation. The representation functions as a graph-like abstraction maintained entirely within the system, enabling cross-database dependency resolution without replicating or migrating underlying data.

When a data access request is received from an external computing entity, the hardware processor invokes the workload coordination unit to perform request analysis. The request is parsed to identify logical data dependencies, target entities, and required operations. Based on the unified internal structural representation, the workload coordination unit decomposes the request into discrete execution fragments, each fragment being constrained to operate within a single database instance and aligned with the execution semantics of that database type. This decomposition ensures that cross-database joins are logically resolved at the orchestration layer rather than at the database layer, thereby preserving database isolation and improving security containment.

Before execution, each execution fragment is processed by the security policy enforcement unit. This unit evaluates access permissions, identity credentials, data sensitivity classifications, and cloud residency constraints associated with the fragment. Based on this evaluation, cryptographic protection parameters are applied at a granularity appropriate to the target database type, such as record-level, document-level, relationship-level, or attribute-level protection. Key material and access rules are maintained independently for each cloud environment, preventing cross-cloud credential leakage and enforcing jurisdictional compliance.

Once secured, the execution fragments are scheduled by the workload coordination unit. Scheduling decisions are influenced by real-time feedback received from the cloud environment coordination unit, which continuously monitors cloud resource availability, network latency, fault indicators, and compliance boundaries. The technique dynamically adjusts execution ordering and routing paths to avoid congested or degraded cloud environments while preserving transactional consistency and execution correctness. This adaptive behavior allows the system to maintain service continuity even under partial cloud outages.

During execution, the cyber threat analysis unit actively monitors behavioral characteristics associated with each fragment. This includes tracking access frequency, execution timing patterns, traversal sequences across database types, and correlations between successive database interactions. These observations are compared against baseline behavioral fingerprints previously generated and stored in the memory. The fingerprints represent statistically stable operational patterns derived from historical execution data and are continuously refined over time.

If the cyber threat analysis unit detects deviations exceeding predefined tolerance thresholds, a threat state indicator is generated. The threat state indicator triggers technique responses that may include suspending affected execution fragments, rerouting execution paths, enforcing additional cryptographic constraints, or isolating specific database interfaces. Importantly, these responses are applied selectively at the fragment level, allowing unaffected portions of the request to complete execution without interruption.

Throughout the orchestration process, the system maintains a distributed execution ledger stored in the memory. The ledger records provenance information such as originating database identifiers, applied security policies, execution timestamps, and cloud environment identifiers. This ledger enables post-execution forensic analysis and compliance auditing without exposing raw data contents, thereby maintaining confidentiality while supporting traceability.

Upon completion of execution, validated results from individual execution fragments are consolidated by the hardware processor into a unified response. Prior to release, the response undergoes final consistency verification to ensure that no restricted data paths were traversed and that no unresolved threat indicators remain active. Only after successful verification is the consolidated response transmitted to the requesting external computing entity.

The flow enables the system to provide cybersecure, adaptive, and compliant orchestration of heterogeneous databases across multi-cloud environments using hardware-executed coordination logic. By operating entirely through controlled interfaces and processor-driven execution control, the invention achieves a technical effect of improved security containment, reduced attack surface, and resilient multi-database orchestration without altering existing database infrastructure.

In accordance with one embodiment, the invention comprises an intelligent cybersecure data system implemented as a machine-readable infrastructure including a physical or virtualized orchestration device deployed within a multi-cloud environment. The system structurally includes a central orchestration engine operatively coupled to a plurality of database interface modules, each interface module being specifically configured to communicate with a corresponding database type selected from relational databases, NoSQL databases, graph databases, and analytical databases. These interface modules normalize database-specific protocols, query semantics, and transaction models into a unified orchestration representation.

The orchestration engine further includes cyber-security intelligence module implemented using one or more processors configured to execute artificial intelligence and machine learning models trained on historical database behavior, access telemetry, and threat intelligence feeds. This cybersecurity intelligence module continuously analyzes database interaction patterns, authentication events, query structures, and data access sequences to establish behavioral baselines and detect deviations indicative of cyber threats, misconfigurations, or unauthorized activity.

In one embodiment, the system incorporates a cryptographic verification subsystem comprising encryption engines, digital signature generators, and secure key management hardware or software modules. This subsystem ensures that data-in-transit and data-at-rest across all orchestrated databases are protected using adaptive encryption policies, while also generating cryptographic fingerprints and integrity proofs that enable verifiable data lineage and tamper detection across cloud boundaries.

The system further includes a multi-cloud management layer structurally interfaced with cloud

service provider control planes. This layer dynamically provisions, scales, and reassigns database workloads across different cloud environments based on orchestration decisions informed by performance metrics, cost constraints, security posture, and regulatory requirements. The orchestration engine continuously evaluates cloud-specific trust levels and security capabilities before executing cross-cloud database operations.

From a machine architecture perspective, the system operates as a distributed orchestration fabric wherein orchestration logic, security intelligence, and database coordination functions are partitioned across multiple computing nodes while maintaining a logically unified control plane. This architecture ensures fault tolerance, scalability, and high availability while preserving consistent security enforcement.

The invention also discloses a method for orchestrating cybersecure database operations in a multi-cloud environment. The method begins by receiving database operation requests originating from enterprise applications, analytics engines, or external services. Each request is parsed and classified according to database type requirements, data sensitivity, and execution context.

The method then performs real-time authentication and authorization by validating request credentials, contextual attributes, and historical behavior against security policies enforced by the cybersecurity intelligence module. Upon successful validation, the method dynamically selects an appropriate target database and cloud environment by evaluating workload characteristics, current system state, and security risk indicators.

Subsequently, the method executes the database operation through the corresponding database interface module while continuously monitoring execution behavior, response patterns, and data access scope. Cryptographic verification is applied to ensure integrity and non-repudiation of the operation. If anomalous behavior is detected at any stage, the method triggers adaptive security

responses including throttling, isolation, re-routing, or termination of the operation.

The method further records comprehensive orchestration logs and security telemetry, which are fed back into the machine learning models to continuously refine threat detection accuracy, orchestration efficiency, and policy effectiveness over time.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A computer-implemented method for cybersecure orchestration of heterogeneous databases across multi-cloud computing environments, the method being executed by at least one hardware processor operatively coupled to a non-transitory memory, and comprising the steps of:
establishing, by a database interface unit, concurrent communication sessions with a plurality of database instances deployed across different cloud infrastructures, the plurality of database instances comprising at least one relational database instance, at least one non-relational database instance, at least one graph-structured database instance, and at least one analytical database instance, each communication session being established using a database-specific interaction protocol;
extracting, by a data schema interpretation unit executed on the hardware processor, structural metadata from each connected database instance, the structural metadata comprising schema definitions, relationship descriptors, indexing attributes, query constraints, and execution capabilities obtained through native catalog interrogation without modifying stored data;
constructing, in the memory, a unified internal structural representation based on the extracted structural metadata, the unified internal structural representation defining normalized entities, inter-database relationship mappings, and dependency constraints across the heterogeneous database instances;
receiving, by the hardware processor, a data access request originating from an external computing entity, and decomposing the data access request into a plurality of execution fragments based on the unified internal structural representation;
applying, by a security policy enforcement unit, access control constraints, cryptographic protection parameters, and identity verification rules to each execution fragment prior to execution, the applied constraints being determined based on database type, data sensitivity classification, and cloud residency requirements;
scheduling, by a workload coordination unit, the secured execution fragments across the plurality of database instances while preserving transactional ordering, dependency resolution, and referential integrity across database boundaries;
monitoring, by a cyber threat analysis unit, execution behavior associated with the scheduled execution fragments, including access frequency, traversal sequence, execution timing, and cross-database interaction patterns;
generating, by the cyber threat analysis unit, a threat state indicator when observed execution behavior deviates from stored baseline behavioral profiles maintained in the memory;
adapting, by a cloud environment coordination unit, execution routing and scheduling decisions in response to detected threat state indicators, cloud resource availability, or network condition changes; and
returning a consolidated response to the external computing entity only after successful completion of security validation and execution consistency verification; wherein establishing concurrent communication sessions comprises initializing isolated protocol-bound communication adapters for each database instance, such that query translation, response normalization, and error handling are performed independently for each database type to prevent cross-database fault propagation; and wherein extracting structural metadata further comprises performing read-only introspection operations to derive schema evolution history, constraint enforcement rules, and query optimization hints without issuing data modification commands to the connected database instances.

2. The method of claim 1, wherein decomposing the data access request comprises partitioning the request into execution fragments aligned with database-specific query capabilities and data locality constraints, such that each execution fragment is executable within a single database instance without requiring direct cross-database joins, and wherein applying cryptographic protection parameters comprises selecting encryption granularity based on database type, including record-level encryption for relational databases, document-level encryption for non-relational databases, relationship-level encryption for graph databases, and attribute-level encryption for analytical databases.

3. The method of claim 1, wherein monitoring execution behavior further comprises generating temporal correlation data representing ordered sequences of database access events occurring within a defined time window across multiple database instances deployed in different cloud infrastructures, wherein generating the threat state indicator comprises comparing the temporal correlation data against historical execution fingerprints stored in the memory and determining lateral traversal risk based on deviation magnitude and sequence abnormality, and wherein adapting execution routing further comprises rerouting selected execution fragments to alternative cloud infrastructures when latency thresholds, service degradation indicators, or jurisdictional compliance violations are detected.

4. The method of claim 1, wherein scheduling the secured execution fragments further comprises maintaining a distributed execution ledger in the memory, the ledger recording provenance information including originating database identifiers, applied security policies, execution timestamps, and cloud environment identifiers, and wherein generating the consolidated response further comprises suppressing partial execution results associated with execution fragments that triggered a threat state indicator, while allowing completion of unaffected execution fragments.

5. The method of claim 1, wherein constructing the unified internal structural representation further comprises generating a cross-database semantic binding layer in the memory that assigns persistent logical identifiers to normalized entities derived from the structural metadata of each database instance, the semantic binding layer further storing bidirectional translation rules mapping database-native data types, constraint expressions, and relationship cardinalities into canonical execution models, and wherein decomposing the data access request further comprises resolving entity references within the request against the semantic binding layer to dynamically substitute database-native field identifiers and join semantics at execution time without modifying the unified internal structural representation.

6. The method of claim 1, wherein establishing the concurrent communication sessions further comprises dynamically allocating isolated protocol-bound communication adapters within separate execution sandboxes, each sandbox maintaining an independent connection pool, retry policy, transaction scope, and query rewrite engine, and wherein the query rewrite engine is configured to transform decomposed execution fragments into database-native execution statements based on the extracted structural metadata and stored optimization hints, while suppressing unsupported operations and injecting execution guards to prevent recursive traversal and resource exhaustion across the heterogeneous database instances.

7. The method of claim 1, wherein applying the access control constraints further comprises performing attribute-level authorization resolution by intersecting identity context received from the external computing entity with column-level, field-level, or relationship-level security descriptors stored in the memory, and dynamically embedding filtered projection rules into each execution fragment such that unauthorized attributes are excluded prior to transmission to the corresponding database instance, and wherein the identity verification rules further comprise validating cryptographic session tokens against a federated identity trust registry distributed across the multi-cloud computing environments.

8. The method of claim 1, wherein monitoring the execution behavior further comprises generating a multi-dimensional behavior vector for each execution fragment, the multi-dimensional behavior vector comprising access depth, query fan-out, cross-instance propagation distance, execution latency variance, and data volume transfer rate, and wherein generating the threat state indicator further comprises classifying the multi-dimensional behavior vector against adaptive baseline envelopes stored in the memory that are dynamically recalibrated based on historical workload periodicity and cloud infrastructure performance drift.

9. The method of claim 1, wherein adapting the execution routing and scheduling decisions further comprises computing a trust-weighted routing score for each candidate cloud infrastructure using threat state history, network latency statistics, and compliance region policies stored in the memory, and dynamically reassigning execution fragments to target database instances that satisfy a minimum trust-weight threshold while preserving inter-fragment dependency constraints encoded in the unified internal structural representation.

10. The method of claim 1, wherein constructing the unified internal structural representation further comprises generating a dependency resolution graph in the memory that encodes inter-fragment execution precedence, shared resource locks, and referential constraint propagation paths, and wherein scheduling the secured execution fragments further comprises traversing the dependency resolution graph to serialize or parallelize execution fragments based on detected contention, lock scope overlap, and transaction isolation requirements associated with the heterogeneous database instances.

11. The method of claim 1, wherein receiving the data access request further comprises parsing the request into an intermediate canonical query form stored in the memory, the canonical query form defining abstract entity references, predicate trees, and aggregation semantics independent of database-specific syntax, and wherein decomposing the data access request further comprises mapping the canonical query form into execution fragments using rule-driven pattern substitution tables derived from the unified internal structural representation.

12. The method of claim 1, wherein generating the threat state indicator further comprises assigning a dynamic threat confidence score computed from weighted deviation factors associated with access frequency anomalies, traversal path irregularities, and cross-database correlation entropy, and wherein returning the consolidated response further comprises embedding an execution integrity token that cryptographically binds the response payload to the validated execution fragments and recorded security policy enforcement outcomes.

13. The method of claim 1, wherein the cyber threat analysis unit further maintains rolling behavioral baselines segmented by database type, cloud region, time-of-day, and workload category, and wherein monitoring the execution behavior further comprises continuously updating the rolling behavioral baselines using exponentially decayed historical execution data to accommodate infrastructure drift and evolving access patterns without manual reconfiguration.

14. The method of claim 1, wherein establishing concurrent communication sessions further comprises negotiating capability descriptors with each database instance to determine supported query operators, transaction isolation levels, and indexing mechanisms, and wherein decomposing the data access request further comprises selectively disabling unsupported operations and generating compensating execution fragments that emulate missing functionality through staged query execution across the plurality of database instances.

15. The method of claim 1, wherein returning the consolidated response further comprises validating cross-database consistency by comparing record counts, aggregation checksums, and referential linkage hashes generated by the plurality of database instances against expected values derived from the unified internal structural representation prior to releasing the response to the external computing entity.

16. The method of claim 1, wherein the security policy enforcement unit further comprises a rule compilation engine that transforms policy definitions stored in the memory into executable constraint graphs, each constraint graph encoding permissible data scopes, cryptographic key references, access sequencing conditions, and cloud jurisdiction enforcement parameters, and wherein applying the access control constraints further comprises traversing the constraint graphs to inject runtime policy checks and encrypted data handlers into each execution fragment prior to scheduling.

17. The method of claim 1, wherein extracting the structural metadata further comprises generating versioned schema snapshots for each connected database instance, the versioned schema snapshots being stored in the memory with temporal identifiers and compatibility markers, and wherein constructing the unified internal structural representation further comprises resolving schema version conflicts by applying precedence rules and structural normalization mappings to maintain backward compatibility during execution fragment generation.

18. The method of claim 1, wherein monitoring the execution behavior further comprises correlating database audit logs, network telemetry, and execution trace metadata to generate a cross-layer activity profile for each execution fragment, and wherein generating the threat state indicator further comprises evaluating the cross-layer activity profile against composite risk signatures stored in the memory that encode known lateral movement patterns, privilege escalation behaviors, and anomalous access propagation structures; and wherein adapting the execution routing and scheduling decisions further comprises dynamically modifying fragment execution priority queues stored in the memory based on detected threat state indicators, cloud resource utilization metrics, and transaction urgency parameters, and selectively delaying, accelerating, or isolating execution fragments within secure execution pools to maintain consistency and security across the multi-cloud computing environments.
